(19) United States
(12) Patent Application Publication
(10) Pub. No.: US 2018/0345823 A1
(43) Pub. Date: Dec. 6, 2018

(54) SEAT ASSEMBLY ADJUSTMENT PATTERNS

(71) Applicants: Winsen C. ZOUZAL, (US); Lear Corporation, Southfield, MI (US)

(72) Inventors: Winsen C. ZOUZAL, Detroit, MI (US); Gerald PATRICK, Shelby Township, MI (US); Samuel HANLON, Livonia, MI (US); Michelle A. PERENY, Farmington Hills, MI (US); Marie-Eve COTE, Royal Oak, MI (US)

(21) Appl. No.: 15/916,417

(22) Filed: Mar. 9, 2018

Related U.S. Application Data
(60) Provisional application No. 62/513,531, filed on Jun. 1, 2017.

(51) Int. Cl. B60N 2/02

(52) U.S. Cl. CPC B60N 2/0244; B60N 2/62; B60N 2/0296; B60N 2002/0272

(57) ABSTRACT

A seat assembly is provided with a seat bottom and a seat back. A first actuator is oriented in a lower lumbar region. A second actuator is oriented in an upper lumbar region. A controller is programmed to operate the first actuator to adjust the lower lumbar region, and operate the second actuator to subsequently adjust the upper lumbar region to provide a seat assembly motion pattern. A third actuator is oriented in a thoracic region or a seat bottom region. The controller operates the third actuator to adjust the thoracic region or the seat bottom region after adjusting the lumbar regions to provide a seat assembly motion pattern. A plurality of sensors is provided on the seat back and the seat bottom to initiate the pattern in response to a lack of detected occupant motion to induce muscle activation upon an occupant.

### CROSS-REFERENCE TO RELATED APPLICATIONS

This application claims the benefit of U.S. provisional application Ser. No. 62/513,531 filed Jun. 1, 2017, the disclosure of which is hereby incorporated in its entirety by reference herein.

### TECHNICAL FIELD

Various embodiments relate to adjustable seat assemblies.

### BACKGROUND

An adjustable seat assembly is disclosed in U.S. Patent Application Publication No. US 2015/0352990 A1, which published on Dec. 10, 2015 to Zouzal et al.

### SUMMARY

According to at least one embodiment, a seat assembly is provided with a seat bottom and seat back extending generally upright relative to the seat bottom. A first actuator is oriented in a lumbar region of the seat back. A second actuator is oriented in at least one of a thoracic region of the seat back and a seat bottom region of the seat bottom. A controller is in electrical communication with the first actuator and the second actuator, and is programmed to operate the first actuator to adjust the lumbar region of the seat back, and operate the second actuator to adjust the at least one of the thoracic region of the seat back and the seat bottom region after adjusting the lumbar region to provide a seat assembly motion pattern.

According to at least another embodiment, a seat assembly is provided with a seat back. A first actuator is oriented in a first lumbar region of the seat back. A second actuator is oriented in a second lumbar region of the seat back oriented above the first lumbar region in an upright direction of the seat back. A controller is in electrical communication with the first actuator and the second actuator, and is programmed to operate the first actuator to adjust the first lumbar region of the seat back, and operate the second actuator to adjust the second lumbar region of the seat back after adjusting the first lumbar region to provide a seat assembly motion pattern.

According to at least another embodiment, a seat assembly is provided with a seat bottom and a seat back extending generally upright relative to the seat bottom. A first actuator is oriented in a first region of the seat assembly. A second actuator is oriented in a second region of the seat assembly. A plurality of sensors is provided on at least one of the seat back and the seat bottom. A controller is in electrical communication with the first actuator, the second actuator, and the plurality of sensors. The controller is programmed to operate the first actuator to adjust the first region of the seat assembly in response to a lack of detected occupant motion from the plurality of sensors. The second actuator is operated to adjust the second region of the seat assembly after adjusting the first region to provide a seat assembly motion pattern to induce muscle activation upon an occupant.

### BRIEF DESCRIPTION OF THE DRAWINGS

FIG. 1 is a perspective view of a seat assembly according to an embodiment;

FIG. 2 is a perspective view of the seat assembly of FIG. 1, illustrated partially disassembled;

FIG. 3 is a flowchart of a seat assembly motion pattern of the seat assembly of FIG. 1 according to an embodiment; and

FIG. 4 is a flowchart of another seat assembly motion pattern of the seat assembly of FIG. 1 according to another embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A comfort, posture and wellness seating system for vehicle seat assemblies, provides a visual interface with adjustment hardware organically or inorganically. The system may be employed to properly configure any new or existing seating system. The system can also address specific comfort, posture or preferences, such as thoracic support. The seating system objectifies comfort data and biomechanical knowledge to make the data transferable.

The comfort, posture and wellness seating system integrates anthropometry, bio-mechanics, and historical seating comfort data. The seating system can be employed in original equipment for vehicles or in aftermarket products. Applicable markets include automotive, mass transit, airlines, etc., as well as non-vehicular seating such as office, home, commercial, and public venue seating.

Data collection may be conducted that includes expert positioning of a suitable sample of occupants for optimal comfort or preferred posture by a medical professional. The data collection can be used at specific sites on an ongoing basis if required. The expert input provides a high level of expert comfort, posture and personalized fitting. The data may be based on anthropometry, body pressure distribution (BPD), status of actuators (such as pressure of inflatable air bladders, status of valves or the like), or other data that provides a comfort, posture and biomechanically optimized position of an adjustable vehicle seat assembly. The data is collected in a knowledge base or table for setting adjustments based on categories of data. The knowledge base may be compiled from the expert positioned data and the occupant specific data. The setting adjustments from the knowledge base are utilized for pre-set options in a vehicle seat assembly 10. The setting adjustments can be customized by a user at a controller or display.

Input data can be plotted versus adjustment settings for high level categorization. The settings can be categorized by topology clustering for setting the pre-set options. Various setting options may be provided for various types of driving. For example, a touring setting may provide per package settings and basic comfort, posture and wellness recommendations. The touring setting may also provide optimal visibility, use of features and controls, and the like. A performance setting may be provided for active drivers to provide a more erect position with firmer seating. Additionally, a luxury setting may be more reclined with softer seating.

It is believed that supporting the thoracic region of the spine can reduce forces and support as much as one-third of the upper body mass. By increasing support of the upper body mass, loads are reduced on the muscles, vertebrae, and discs through the spine and pelvic regions. Decreased load reduces fatigue on these areas of the body. The current prevalent comfort back-supporting technology for the furniture and transportation market focuses on the lumbar (lower) region of the back to provide relief from fatigue. With the change from a primarily labor intensive work force to one of computer-using desk workers, we see an increase in low back pain. This is driving the pursuit for an improvement in the location of the seating support system designed to prevent fatigue and the resultant discomfort. By transferring support from solely located in the lumbar region to now include the thoracic region of the spine, load is transferred to a more rigid section of the spinal column as well and a decrease in lower back pain should result.

A seating system for office or home seating furniture or vehicular seating systems, such as in automotive, train, off-road vehicular or aircraft seating, provides supporting pressure along the thoracic region of the user's spine between the T1 to the T12 vertebrae, and additional support in the lumbar region. The region above the T1 vertebrae is the cervical region; and the regions below the T12 vertebrae are the lumbar, sacral and coccyx regions.

The support structure is to be positioned along the thoracic region of a seat back when the user is seated. The support structure can be used in a variety of seating systems. Some seating systems and components are shown by way of example and are described below.

There are four main factors that affect subjective posture: 1) smoothness of the pressure integral; 2) sufficiency of the pressure change; 3) ability to create even pressure for a wide range of anthropometry; and 4) ergonomic/control suitability of actuation.

A thoracic region seating system design is focused on addressing subjective posture factors. By supporting the thoracic region, the user's load is transferred from the lumbar region to the thoracic region, reducing stress and fatigue in the muscles, tendons, and vertebrae. A proper thoracic support position enhances respiratory functions over extended periods of time.

A design feature permits even pressure for a wide range of anthropometry, which can be accommodated by having the degree of pressure adjustable.

Lack of occupant movement or seat activation for long periods of time during travel can lead to discomfort and an unbalanced seating position. Regular movement and stimulation can lead to improved comfort and an overall positive driving experience.

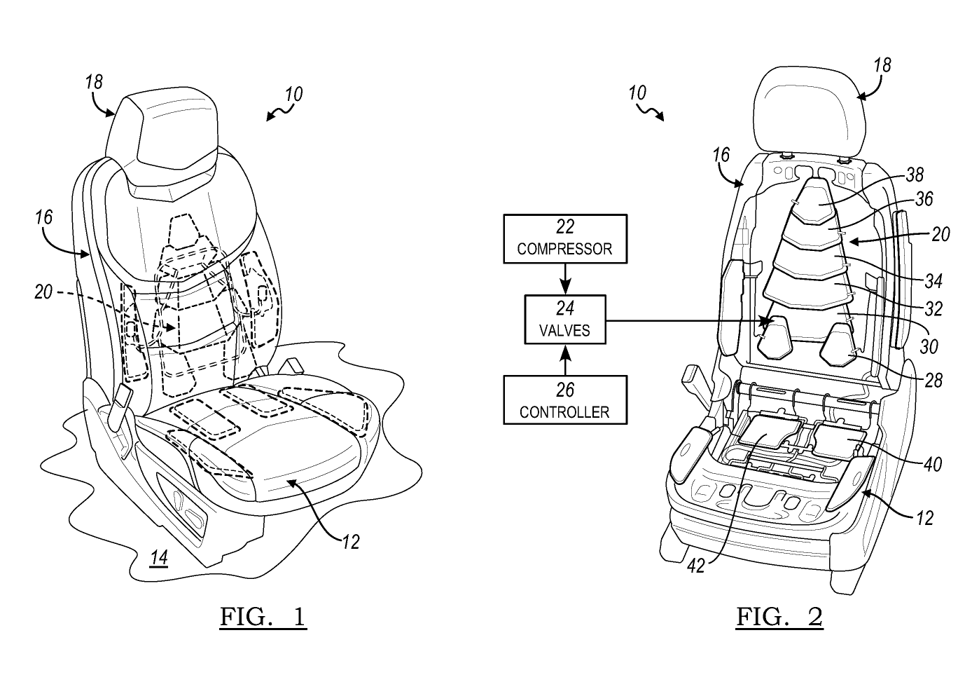

Referring now to FIG. 1, a seat assembly is illustrated and is referenced generally by numeral 10. The seat assembly 10 may be a vehicle seat such as for an automobile or an aircraft, an office chair, or any seat assembly that can benefit by an adjustable posture system. The seat assembly 10 includes a seat bottom 12 with hardware to mount to a vehicle floor 14. A seat back 16 extends upright from the seat bottom 12 and is adjustable in recline and incline relative to the seat bottom 12. A head restraint 18 is supported atop the seat back 16.

The seat assembly 10 is illustrated with an array of bladder assemblies 20 that are each adjustable and can be individually or collectively inflated providing support and stimulation at various locations in the seat intended to accommodate different sized and statured individual occupants. FIG. 2 illustrates the seat assembly 10 as partially disassembled to reveal the underlying components, including the array of bladder assemblies 20. According to one embodiment, the array of bladders assemblies 20 is a power pneumatic system which provides support and stimulation to support an occupant to achieve a proper neutral seating posture. The array of bladder assemblies 20 may also utilize pneumatic bag acupressure to stimulate specific pressure points along both sides of the spine to deactivate trigger points which create positive muscle response. The supports are also inflated and deflated in a specific pattern to create a myofascial release effect to improve wellness and to assist thoracic support by stimulation.

The seat assembly 10 includes a compressor 22 for providing a source of pressurized air to valves 24. The valves 24 are controlled by a controller 26. The valves 24 are in fluid communication with the array of bladder assemblies 20 for controlling pressure and inflation of the array of bladder assemblies 20. Likewise, the valves 24 may exhaust air for deflation of the zones. The controller 26 may operate as described in Lear Corporation U.S. Patent Application publication number US 2015/0352979 A1, which is incorporated in its entirety be reference herein. The controller 26 permits individual adjustment of pressure of each of the array of bladder assemblies 20 as specified by an occupant selection or a predetermined pressure setting or program.

The array of air bladder assemblies 20 is provided in the seat bottom 12 and the seat back 16. The array of air bladder assemblies 20 includes a pair of lower lumbar air bladder assemblies 28 provided in a lower lumbar region of the seat back 16. A mid-lumbar air bladder assembly 30 is also provided in the lumbar region of the seat back 16 and spaced at least partially above the pair of lower lumbar air bladder assemblies 28 with partial overlap of the lower lumbar air bladder assemblies 28 over the mid-lumbar air bladder assembly 30. An upper lumbar air bladder assembly 32 is provided in the lumbar region of the seat back 16 and spaced at least partially above and partially overlapping the mid-lumbar air bladder assembly 30. The lumbar air bladder assemblies 28, 30, 32 are sized and oriented within a region associated with L1-L5 vertebrae for an average occupant.

The array of air bladder assemblies 20 also includes a lower thoracic air bladder assembly 34 provided in a thoracic region of the seat back 16. The lower thoracic air bladder assembly 34 is oriented above and may partially overlap the upper lumbar air bladder assembly 32. A mid-thoracic air bladder assembly 36 is provided above and partially overlapping the lower lumbar air bladder assembly 32. Likewise, an upper thoracic air bladder assembly 38 is provided above and partially overlapping the mid-thoracic air bladder assembly 36.

The thoracic air bladder assemblies 34, 36, 38 are sized to be located between the shoulder blades and between the T1 and T12 vertebrae for an average occupant. Each of the thoracic air bladder assemblies 34, 36, 38 is tapered inward in an upright direction of the seat back 16 to fit between an occupant's shoulder blades.

The array of air bladder assemblies 20 includes a pair of air bladder assemblies 40, 42 spaced laterally apart within the seat bottom 12. The air bladder assemblies 40, 42 are designated as a left cushion air bladder assembly 40 and right cushion air bladder assembly 42 per the left and right from an occupant's perspective.

An array of air pressure sensors may be provided in the air bladder assemblies 28, 30, 32, 34, 36, 38, 40, 42 to measure air pressure readings that are conveyed to the controller 26. The controller 26 may receive adjustment settings from pre-set data or from customized data. The data may be input from an interface that is provided in the vehicle. The interface may be integrated into the vehicle, such as an instrument panel display that is in suitable wired or wireless communication with the controller 26. The interface may be remote, such as a personal digital assistant (PDA) including phones, tablets and the like. The interface may be provided as a smart device application, wherein users enter relevant information about themselves. The smart device interface may not require on-site expertise or seat properties. The remote interface permits a user to transport settings to each vehicle, such as personal passenger vehicles, airline seating, rental cars, and the like.

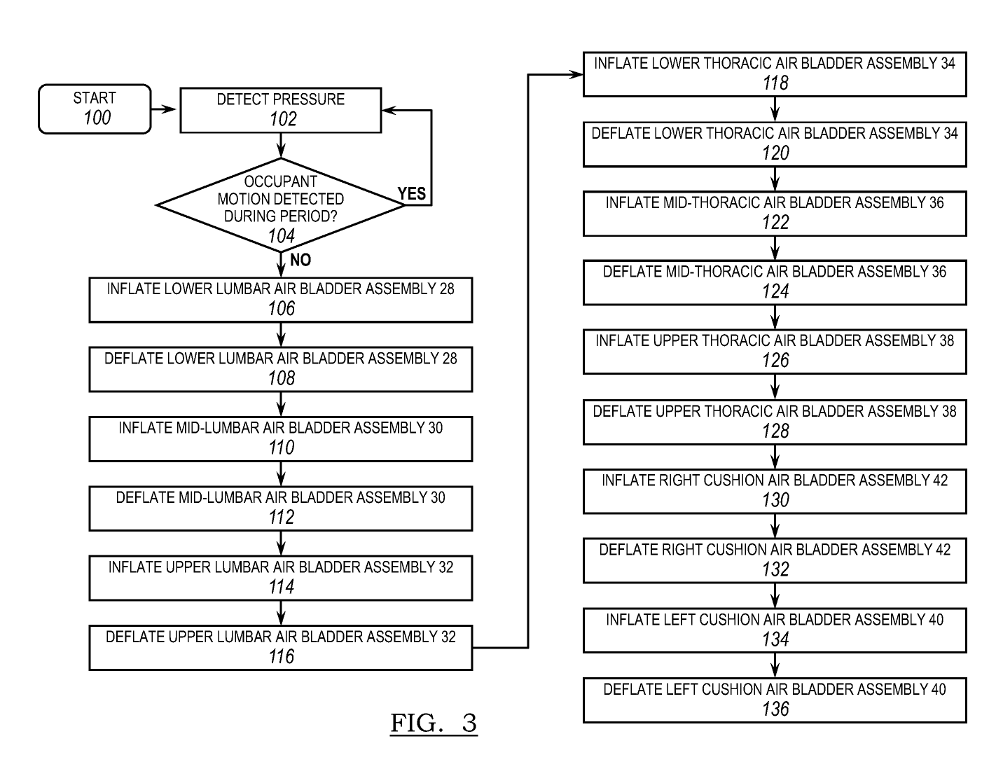

The seat assembly 10 includes motion patterns to refresh a seating position to induce muscle activation and to create a myofascial release effect. One example for a seat assembly wave pattern is illustrated in FIG. 3 with continued reference to FIG. 2. The method for the wave pattern starts at block 100. At block 102, the controller 26 detects the pressure from the air bladder assemblies 28, 30, 32, 34, 36, 38, 40, 42. At block 104, the controller 26 determines if there has been any occupant movement over a predetermined period of time. According to one embodiment, the period of time may be seven minutes. Under another example, the period of time may be twenty minutes.

If an occupant motion is detected within the period of time at block 104, the timer is reset and pressure detection at block 102 is repeated. However, if no occupant movement is detected at block 104, the wave pattern is initiated at block 106. According to another embodiment, the seat assembly motion pattern may be initiated after a period of time regardless of occupant motion.

At block 106, the lower lumbar air bladder assembly 28 is fully inflated. The controller 26 controls the valve 24 to release air from the compressor 22 into the lower lumbar air bladder assembly 28. Although valves 24 and air bladder assemblies 28, 30, 32, 34, 36, 38, 40, 42 are illustrated and described, any known actuator is contemplated for adjusting the seat assembly 10. Although the lower lumbar air bladder assembly 28 is fully inflated, any percentage of inflation is contemplated. The lower lumbar air bladder assembly 28 may be fully inflated from a deflated condition, or from a partial inflation starting from a prior manual or automatic adjustment.

Subsequently, at block 108, the lower lumbar air bladder assembly 28 is fully deflated. The mid-lumbar air bladder assembly 30 is inflated at block 110 and subsequently deflated at block 112. The upper lumbar air bladder assembly 32 is inflated at block 114 and subsequently deflated at block 116.

After the wave pattern is sequenced through the lumbar air bladder assemblies 28, 30, 32, the pattern is continued through the thoracic air bladder assemblies 34, 36, 38. At block 118, the lower thoracic air bladder assembly 34 is inflated. At block 120, the lower thoracic air bladder assembly 34 is deflated. The mid-thoracic air bladder assembly 36 is inflated at block 122, and subsequently deflated at block 124. The upper thoracic air bladder assembly 38 is inflated at block 126 and deflated at block 128.

After the wave pattern passes through the lumbar and thoracic air bladder assemblies 28, 30, 32, 34, 36, 38, the pattern is passed to the air bladder assemblies 40, 42 in the seat bottom 12. At block 130, the right cushion air bladder assembly 42 is inflated, and subsequently, the right cushion air bladder assembly 42 is deflated at block 132. Next, the left cushion air bladder assembly 40 is inflated at block 134, and then deflated at block 136.

After the wave pattern of FIG. 3 is subjected to the occupant with a sequential and incremental focus upon back regions, blood circulation is stimulated, and the occupant may feel refreshed for continued travel. The wave pattern stimulates targeted areas of the occupant's back by separating the thoracic and lumbar regions into sub-regions. After completion of the method of FIG. 3, the controller 26 may return each of the air bladder assemblies 28, 30, 32, 34, 36, 38, 40, 42 to an inflation setting prior to the initiation of the wave pattern to return the occupant to the previous seating position.

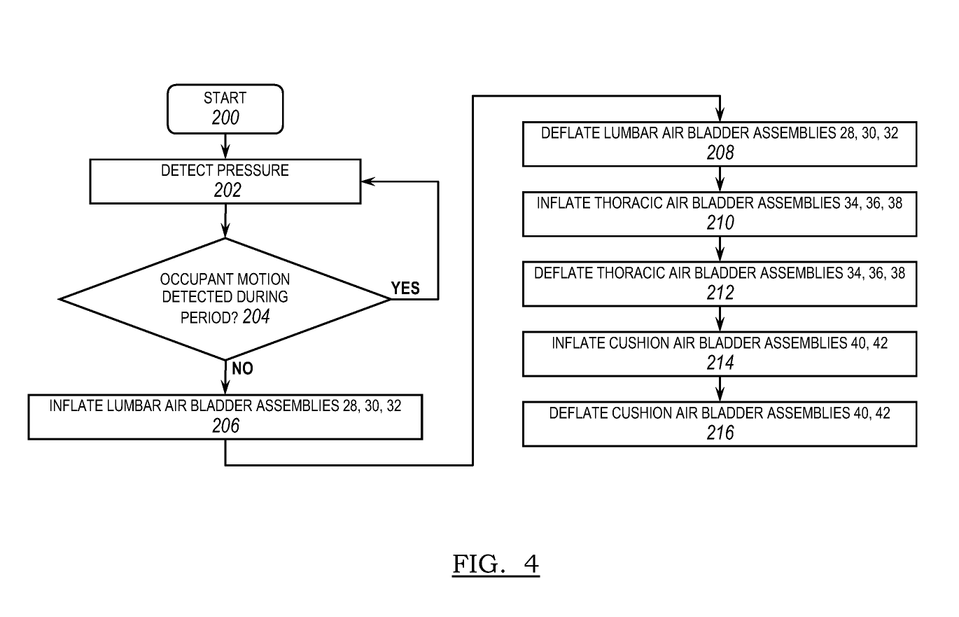

The seat assembly 10 may include a stretch pattern to refresh a seating position to induce muscle activation and to create a myofascial release effect. The method stretch pattern is illustrated in FIG. 4 with continued reference to FIG. 2. The method for the stretch pattern starts at block 200. At block 202, the controller 26 detects the pressure from the air bladder assemblies 28, 30, 32, 34, 36, 38, 40, 42. At block 204, the controller 26 determines if there has been any occupant movement over a predetermined period of time.

If an occupant motion is detected within the period of time at block 204, the timer is reset and pressure detection at block 202 is repeated. However, if no occupant movement is detected at block 204, the stretch pattern is initiated at block 206. At block 206, the lower lumbar air bladder assembly 28, the mid-lumbar air bladder assembly 30 and the upper lumbar air bladder assembly 32 are fully inflated. Subsequently, at block 208, the lumbar air bladder assemblies 28, 30, 32 are fully deflated.

After the wave pattern is sequenced through the lumbar air bladder assemblies 28, 30, 32, the pattern is continued through the thoracic air bladder assemblies 34, 36, 38. At block 210, the lower thoracic air bladder assembly 34, mid-thoracic air bladder assembly 36, and the upper thoracic air bladder assembly 38 are inflated. At block 210, the thoracic air bladder assemblies 34, 36, 38 are deflated.

After the wave pattern passes through the lumbar and thoracic air bladder assemblies 28, 30, 32, 34, 36, 38, the pattern is passed to the air bladder assemblies 40, 42 in the seat bottom 12. At block 214, the left cushion air bladder assembly 40 and the right cushion air bladder assembly 42 are inflated, and subsequently, the cushion air bladder assemblies 40, 42 are deflated at block 216.

After the stretch pattern of FIG. 4 is subjected to the occupant with a sequential and broadened focus on large back regions, blood circulation is stimulated, and the occupant may feel refreshed for continued travel, similar to stretching the muscles of the back. After completion of the method of FIG. 4, the controller 26 may return each of the air bladder assemblies 28, 30, 32, 34, 36, 38, 40, 42 to an inflation setting prior to the initiation of the wave pattern to return the occupant to the previous seating position.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A seat assembly comprising:
a seat bottom;
a seat back extending generally upright relative to the seat bottom;
a first actuator oriented in a lumbar region of the seat back;
a second actuator oriented in at least one of a thoracic region of the seat back and a seat bottom region of the seat bottom; and
a controller in electrical communication with the first actuator and the second actuator, and programmed to:
operate the first actuator to adjust the lumbar region of the seat back, and
operate the second actuator to adjust the at least one of the thoracic region of the seat back and the seat bottom region after adjusting the lumbar region to provide a seat assembly motion pattern.

2. The seat assembly of claim 1 wherein the second actuator is oriented in the thoracic region of the seat back;
wherein the seat assembly further comprises a third actuator oriented in the seat bottom in electrical communication with the controller; and
wherein the controller is further programmed to operate the third actuator to adjust the seat bottom region after adjusting the lumbar region and the thoracic region to provide the seat assembly motion pattern.

3. The seat assembly of claim 2 wherein the first actuator comprises a first inflation device and a first air bladder assembly in fluid communication with the first inflation device;
wherein the second actuator comprises a second inflation device and a second air bladder assembly in fluid communication with the second inflation device; and
wherein the third actuator comprises a third inflation device and a third air bladder assembly in fluid communication with the third inflation device.

4. The seat assembly of claim 3 wherein the controller is further programmed to:
operate the first inflation device to full inflation of the first air bladder assembly to adjust the lumbar region of the seat back;
operate the first inflation device to full deflation of the first air bladder assembly to further adjust the lumbar region of the seat back after the full inflation of the first air bladder assembly;
operate the second inflation device to full inflation of the second air bladder assembly to adjust the thoracic region of the seat back after the full deflation of the first air bladder assembly to provide the seat assembly motion pattern; and
operate the second inflation device to full deflation of the second air bladder assembly to further adjust the thoracic region of the seat back after the full inflation of the second air bladder assembly to provide the seat assembly motion pattern.

5. The seat assembly of claim 4 wherein the controller is further programmed to:
operate the third inflation device to full inflation of the third air bladder assembly to adjust the seat bottom region after the full deflation of the second air bladder assembly to provide the seat assembly motion pattern.

6. The seat assembly of claim 1 wherein the first actuator comprises a first inflation device and a first air bladder assembly in fluid communication with the first inflation device; and
wherein the second actuator comprises a second inflation device and a second air bladder assembly in fluid communication with the second inflation device.

7. The seat assembly of claim 6 wherein the controller is further programmed to:
operate the first inflation device to full inflation of the first air bladder assembly to adjust the lumbar region of the seat back;
operate the first inflation device to full deflation of the first air bladder assembly to further adjust the lumbar region of the seat back after the full inflation of the first air bladder assembly; and
operate the second inflation device to full inflation of the second air bladder assembly to adjust the at least one of the thoracic region of the seat back and the seat bottom region after the full deflation of the first air bladder assembly to provide the seat assembly motion pattern.

8. The seat assembly of claim 7 wherein the controller is further programmed to operate the second inflation device to full deflation of the second air bladder assembly to further adjust the at least one of the thoracic region of the seat back and the seat bottom region after the full inflation of the second air bladder assembly to provide the seat assembly motion pattern.

9. The seat assembly of claim 1 wherein the controller is further programmed to operate the first and second actuators after a predetermined period of time to periodically provide the seat assembly motion pattern to induce muscle activation upon an occupant.

10. The seat assembly of claim 1 further comprising a plurality of sensors provided in at least one of the seat back and the seat bottom, in electrical communication with the controller; and
wherein the controller is further programmed to operate the first and second actuators in response to a lack of detected occupant motion from the plurality of sensors to induce muscle activation upon an occupant.

11. The seat assembly of claim 10 wherein the controller is further programmed to operate the first and second actuators in response to the lack of detected occupant motion over a predetermined period of time to induce muscle activation upon the occupant.

12. A seat assembly comprising:
a seat back;
a first actuator oriented in a first lumbar region of the seat back;
a second actuator oriented in a second lumbar region of the seat back oriented above the first lumbar region in an upright direction of the seat back; and
a controller in electrical communication with the first actuator and the second actuator, and programmed to:
operate the first actuator to adjust the first lumbar region of the seat back, and
operate the second actuator to adjust the second lumbar region of the seat back after adjusting the first lumbar region to provide a seat assembly motion pattern.

13. The seat assembly of claim 12 wherein the first actuator comprises a first inflation device and a first air bladder assembly in fluid communication with the first inflation device;
wherein the second actuator comprises a second inflation device and a second air bladder assembly in fluid communication with the second inflation device;
wherein the controller is further programmed to:
operate the first inflation device to full inflation of the first air bladder assembly to adjust the first lumbar region of the seat back,
operate the first inflation device to full deflation of the first air bladder assembly to further adjust the first lumbar region of the seat back after the full inflation of the first air bladder assembly,
operate the second inflation device to full inflation of the second air bladder assembly to adjust the second lumbar region of the seat back after the full deflation of the first air bladder assembly, and
operate the second inflation device to full deflation of the second air bladder assembly to further adjust the second lumbar region of the seat back after the full inflation of the second air bladder assembly to provide the seat assembly motion pattern.

14. The seat assembly of claim 13 further comprising:
a third inflation device in electrical communication with the controller; and
a third air bladder assembly oriented in a third lumbar region of the seat back oriented above the second lumbar region in the upright direction of the seat back, in fluid communication with the third inflation device; and
wherein the controller is further programmed to:
operate the third inflation device to full inflation of the third air bladder assembly to adjust the third lumbar region of the seat back after the full deflation of the second air bladder assembly, and
operate the third inflation device to full deflation of the third air bladder assembly to further adjust the third lumbar region of the seat back after the full inflation of the third air bladder assembly to provide the seat assembly motion pattern.

15. The seat assembly of claim 14 further comprising:
a fourth inflation device in electrical communication with the controller;
a fourth air bladder assembly oriented in a thoracic region of the seat back in fluid communication with the fourth inflation device;
a fifth inflation device in electrical communication with the controller; and
a fifth air bladder assembly oriented in a seat bottom region in fluid communication with the fifth inflation device; and
wherein the controller is further programmed to:
operate the fourth inflation device to full inflation of the fourth air bladder assembly to adjust the thoracic region of the seat back after the full deflation of the third air bladder assembly,
operate the fourth inflation device to full deflation of the fourth air bladder assembly to further adjust the thoracic region of the seat back after the full inflation of the fourth air bladder assembly,
operate the fifth inflation device to full inflation of the fifth air bladder assembly to adjust the seat bottom region after the full deflation of the fourth air bladder assembly, and
operate the fifth inflation device to full deflation of the fifth air bladder assembly to further adjust the seat bottom region after the full inflation of the fifth air bladder assembly to provide the seat assembly motion pattern.

16. The seat assembly of claim 14 further comprising:
a fourth inflation device in electrical communication with the controller;
a fourth air bladder assembly oriented in a first thoracic region of the seat back in fluid communication with the fourth inflation device;
a fifth inflation device in electrical communication with the controller;
a fifth air bladder assembly oriented in a second thoracic region of the seat back oriented above the fourth air bladder assembly in the upright direction of the seat back, in fluid communication with the fifth inflation device;
a sixth inflation device in electrical communication with the controller; and
a sixth air bladder assembly oriented in a third thoracic region of the seat back oriented above the fifth air bladder assembly in the upright direction of the seat back, in fluid communication with the sixth inflation device; and
wherein the controller is further programmed to:
operate the fourth inflation device to full inflation of the fourth air bladder assembly to adjust the first thoracic region of the seat back after the full deflation of the third air bladder assembly,
operate the fourth inflation device to full deflation of the fourth air bladder assembly to further adjust the first thoracic region of the seat back after the full inflation of the fourth air bladder assembly,
operate the fifth inflation device to full inflation of the fifth air bladder assembly to adjust the second thoracic region of the seat back after the full deflation of the fourth air bladder assembly,
operate the fifth inflation device to full deflation of the fifth air bladder assembly to further adjust the second thoracic region of the seat back after the full inflation of the fifth air bladder assembly,
operate the sixth inflation device to full inflation of the sixth air bladder assembly to adjust the third thoracic region of the seat back after the full deflation of the fifth air bladder assembly, and
operate the sixth inflation device to full deflation of the sixth air bladder assembly to further adjust the third thoracic region of the seat back after the full inflation of the sixth air bladder assembly to provide the seat assembly motion pattern.

17. The seat assembly of claim 16 further comprising:
a seventh inflation device in electrical communication with the controller;
a seventh air bladder assembly oriented in a first seat bottom region in fluid communication with the seventh inflation device;
an eighth inflation device in electrical communication with the controller; and
an eighth air bladder assembly oriented in a second seat bottom region of the seat back, spaced apart laterally from the seventh air bladder assembly, in fluid communication with the eighth inflation device; and
wherein the controller is further programmed to:
operate the seventh inflation device to full inflation of the seventh air bladder assembly to adjust the first seat bottom region after the full deflation of the sixth air bladder assembly,
operate the seventh inflation device to full deflation of the seventh air bladder assembly to further adjust the first seat bottom region after the full inflation of the seventh air bladder assembly,
operate the eighth inflation device to full inflation of the eighth air bladder assembly to adjust the second seat bottom region after the full deflation of the seventh air bladder assembly, and
operate the eighth inflation device to full deflation of the eighth air bladder assembly to further adjust the second seat bottom region after the full inflation of the eighth air bladder assembly to provide the seat assembly motion pattern.

18. The seat assembly of claim 14 further comprising:
a fourth inflation device in electrical communication with the controller;
a fourth air bladder assembly oriented in a first seat bottom region in fluid communication with the fourth inflation device;
a fifth inflation device in electrical communication with the controller; and
a fifth air bladder assembly oriented in a second seat bottom region of the seat back, spaced apart laterally from the fourth air bladder assembly, in fluid communication with the fifth inflation device; and
wherein the controller is further programmed to:
operate the fourth inflation device to full inflation of the fourth air bladder assembly to adjust the first seat bottom region after the full deflation of the third air bladder assembly,
operate the fourth inflation device to full deflation of the fourth air bladder assembly to further adjust the first seat bottom region after the full inflation of the fourth air bladder assembly,
operate the fifth inflation device to full inflation of the fifth air bladder assembly to adjust the second seat bottom region after the full deflation of the fourth air bladder assembly, and
operate the fifth inflation device to full deflation of the fifth air bladder assembly to further adjust the second seat bottom region after the full inflation of the fifth air bladder assembly to provide the seat assembly motion pattern.

19. A seat assembly comprising:
a seat bottom;
a seat back extending generally upright relative to the seat bottom;
a first actuator oriented in a first region of the seat assembly;
a second actuator oriented in a second region of the seat assembly;
a plurality of sensors provided on at least one of the seat back and the seat bottom; and
a controller in electrical communication with the first actuator, the second actuator, and the plurality of sensors, and the controller being programmed to:
operate the first actuator to adjust the first region of the seat assembly in response to a lack of detected occupant motion from the plurality of sensors, and
operate the second actuator to adjust the second region of the seat assembly after adjusting the first region to provide a seat assembly motion pattern to induce muscle activation upon an occupant.

20. The seat assembly of claim 19 wherein the controller is further programmed to operate the first and second actuators in response to the lack of detected occupant motion over a predetermined period of time to induce muscle activation upon the occupant.
